(19) United States
(12) Patent Application Publication
(10) Pub. No.: US 2015/0196042 A1
(43) Pub. Date: Jul. 16, 2015

(54) GREEN TEA BEVERAGE PACKED IN CONTAINER AND METHOD OF MANUFACTURING SAME

(71) Applicant: ITO EN, LTD., Tokyo (JP)

(72) Inventors: Masami Sasame, Shizuoka (JP); Kazuto Murayama, Tokyo (JP); Yohsuke Fujii, Shizuoka (JP); Masataka Sakata, Shizuoka (JP)

(21) Appl. No.: 14/380,864

(22) PCT Filed: Oct. 1, 2013
(86) PCT No.: PCT/JP2013/076631

§ 371 Date: Aug. 25, 2014

(30) Foreign Application Priority Data
Oct. 1, 2012 (JP) 2012-219687

(51) Int. Cl. A23F 3/16

(52) U.S. Cl. CPC A23F 3/16

(57) ABSTRACT

A green tea beverage is packed in a container, which makes it possible to sense a deep aroma passing through the nasal cavity when the beverage is drunk cold, in particular even when time has passed since the container was opened and the beverage temperature has increased and become lukewarm, by adjusting the ratio (SSS/SS) of the concentration of settleable suspended solids (SSS) to the concentration of suspended solids (SS) in the green tea beverage to 0.07 to 0.48 and adjusting the ratio (sucrose/sugars) of the concentration of sucrose to the concentration of sugars, which is the sum of the concentration of monosaccharide and the concentration of disaccharide, to 0.74 to 0.94.

The present invention relates to a green tea beverage packed in a container which makes it possible to sense a deep aroma and concentration feeling (richness) in the taste when the beverage is drunk cold, in particular even when time has passed since the container was opened and the beverage temperature has increased and become lukewarm, and in which sediments are prevented from occurring. The present invention also relates to a method of manufacturing the same and a method of maintaining a flavor of a green tea beverage.

### BACKGROUND ART

In recent years, different from the conventional drinking style for green tea using a teapot to make tea, a so-called green tea beverage packed in a container has widely become common. A green tea beverage packed in a container is obtained by filling a container with a green tea extracted liquid, and can readily be drunk.

This has raised a variety of consumer needs for a green tea beverage packed in a container. There are also various drinking scenes for a green tea beverage packed in a container. Rather than drinking hot tea supposed in a case of using a teapot to make green tea, opportunities of directly drinking a refrigerated beverage are increasing and are well-received particularly in hot summer.

Different from the conventional green tea extracted liquid to be drunk hot, a green tea beverage packed in a container to be drunk cold has excellent thirst-quenching ability, but an aroma possessed originally by the green tea may be weakly felt. Among other things, a sweet fire aroma, fresh aroma, fragrant aroma and/or aftertaste may not be felt enough. In particular, since the taste and aroma of a green tea beverage are delicate, there have been considerably high technical hurdles in designing a green tea beverage packed in a container to be drunk cold so that the taste and aroma possessed originally by the green tea can be felt enough, especially compared with other beverages packed in containers.

Besides the technical problems specific to a green tea beverage packed in a container as described above, there have been increasing scenes not seen before in which a cold green tea beverage packed in a container is drunk in small amounts for a long period of time during work, such as job and study, in particular among young people (so-called “slow sipping” (“Chibidaranomi”)). In such drinking scenes, the cold green tea beverage packed in a container becomes lukewarm little by little as time passes, and such a temperature change will deteriorate the refresh feeling, fragrant aroma and aftertaste, which are possessed originally by the green tea beverage, thereby to newly lead to another technical problem in that the balance as a whole may become poor.

To solve the technical problems specific to the variety of drinking scenes and to the green tea beverage, various approaches are performed. For example, Patent Literature 1 discloses a green tea beverage which has strong fire aroma (savory aroma) and has no light taste, and yet gives refreshing aftertaste, and can be drunk delectably even in a cold state. The green tea beverage thus provided is a green tea beverage packed in a container wherein the concentration of sugars, i.e., the sum of the concentration of monosaccharide and the concentration of disaccharide, is 100 ppm to 300 ppm, and the ratio of the concentration of disaccharide relative to the concentration of monosaccharide (disaccharide/monosaccharide) is 10 to 28.

Patent Literature 2 discloses a new green tea beverage, packed in a container, which has spreading aroma in the mouth, afterglow of aroma, and yet has richness and/or concentration feeling in the taste and has aroma note even in a cold state. This green tea beverage packed in a container is provided such that: the concentration of sugars, which is the sum of monosaccharide and disaccharide, is 150 ppm to 500 ppm; the ratio of the concentration of disaccharide relative to the concentration of monosaccharide (disaccharide/monosaccharide) is 2.0 to 8.0; the ratio of the concentration of electron-localized catechin relative to the above-mentioned concentration of sugars (electron-localized catechin/sugars) is 1.8 to 4.0; and the content ratio of furfural relative to geraniol (furfural/geraniol) is 0.5 to 3.0.

However, what are disclosed in Patent Literature 1 and Patent Literature 2 are not those researched under an object to provide a green tea beverage packed in a container which makes it possible to sense a deep aroma passing through the nasal cavity when the beverage is drunk cold, in particular even when time has passed since the container was opened and the beverage temperature has increased and become lukewarm. Also in other patent literature, there is not recognized any technical issue of developing a green tea beverage packed in a container which has such properties.

Furthermore, there has been almost no specific proposal for a method to solve such technical issues.

### [Patent Literature 1] Japan Patent No. 4843118

### [Patent Literature 2] Japan Patent No. 4843119

### DISCLOSURE OF THE INVENTION

### Problems to be Solved by the Invention

An object of the present invention is to provide a green tea beverage packed in a container which makes it possible to sense a deep aroma note and concentration feeling (richness) in the taste in particular even when time has passed since the container was opened and the beverage temperature has increased and become lukewarm, which technical problem would not exist heretofore, while taking advantage of the above knowledge of Prior Art Literature. Another object of the present invention is to provide a method of manufacturing the same and a method of maintaining a flavor of a green tea beverage.

### Means for Solving the Problems

As a result of intensive studies, the present inventors have focused on the relationship between a ratio (SSS/SS) of a concentration of settleable suspended solids (SSS) to a concentration of suspended solids (SS) and a ratio (sucrose/sugars) of a concentration of sucrose to a concentration of sugars which is a sum of a concentration of monosaccharide and a concentration of disaccharide, and the present inventors have found that the above technical problems can be solved by adjusting the ratio (SSS/SS) of the concentration of settleable suspended solids (SSS) to the concentration of suspended solids (SS) in the green tea beverage to 0.07 to 0.48 and adjusting the ratio (sucrose/sugars) of the concentration of sucrose to the concentration of sugars, which is the sum of the concentration of monosaccharide and the concentration of disaccharide, to 0.63 to 0.90, and have thus achieved the present invention.

That is, the present invention relates to:

(1) A green tea beverage packed in a container wherein a ratio (SSS/SS) of a concentration of settleable suspended solids (SSS) to a concentration of suspended solids (SS) is 0.07 to 0.48,

the green tea beverage packed in a container being characterized in that a ratio of a concentration of sucrose to a concentration of sugars (sucrose/sugars) is 0.63 to 0.90, the concentration of sugars being a sum of a concentration of monosaccharide and a concentration of disaccharide;

(2) The green tea beverage packed in a container of (1), characterized in that the concentration of settleable suspended solids (SSS) is 3 to 30 mg/L;

(3) The green tea beverage packed in a container as described in (1) or (2), characterized in that the concentration of sugars, which is the sum of the concentration of monosaccharide and the concentration of disaccharide, is 85 ppm to 330 ppm;

(4) The green tea beverage packed in a container as described in any one of (1) to (3), wherein a ratio of a concentration of electron-localized catechin to the concentration of sugars (electron-localized catechin/sugars) is 1.8 to 3.5;

(5) A method of manufacturing a green tea beverage packed in a container, the method being characterized by comprising: adjusting a ratio (SSS/SS) of a concentration of settleable suspended solids (SSS) to a concentration of suspended solids (SS) in the green tea beverage to 0.07 to 0.48; and adjusting a ratio of a concentration of sucrose to a concentration of sugars (sucrose/sugars) to 0.63 to 0.90, the concentration of sugars being a sum of a concentration of monosaccharide and a concentration of disaccharide; and

(6) A method of maintaining a flavor of a green tea beverage, the method being characterized by comprising: adjusting a ratio (SSS/SS) of a concentration of settleable suspended solids (SSS) to a concentration of suspended solids (SS) in the green tea beverage to 0.07 to 0.48; and adjusting a ratio of a concentration of sucrose to a concentration of sugars (sucrose/sugars) to 0.63 to 0.90, the concentration of sugars being a sum of a concentration of monosaccharide and a concentration of disaccharide.

### Advantageous Effect of the Invention

According to the present invention, there can be obtained a green tea beverage packed in a container which makes it possible to sense a deep aroma and concentration feeling (richness) in the taste in particular even when time has passed since the container was opened and the beverage temperature has increased and become lukewarm.

### BEST MODE FOR CARRYING OUT THE INVENTION

The green tea beverage packed in a container according to the present invention is characterized in that: a ratio (SSS/SS) of a concentration of settleable suspended solids (SSS) to a concentration of suspended solids (SS) is 0.07 to 0.48; and a ratio of a concentration of sucrose to a concentration of sugars (sucrose/sugars) is 0.63 to 0.90, the concentration of sugars being a sum of a concentration of monosaccharide and a concentration of disaccharide.

### MODE FOR CARRYING OUT THE INVENTION

The green tea beverage packed in a container according to the present invention may be a beverage obtained by filling a container with a liquid that contains, as a main component, an extracted liquid obtained by extracting green tea. Examples of the liquid include a liquid that consists only of an extracted liquid obtained by extracting green tea, a liquid obtained by diluting the extracted liquid, a liquid obtained by mixing the extracted liquids with each other, a liquid obtained by adding an additive to any of the above liquids, and a liquid obtained by dispersing those dried of any of the above liquids.

The “main component” as used herein encompasses a meaning that accepts other components to be contained to such an extent that the functionality of the main component is not hindered. Here, the content ratio of the main component is not specified, but the extracted liquid or extracted material obtained by extracting green tea may preferably takes up 50 mass % or more, particularly preferably 70 mass % or more, and further particularly preferably 80 mass % or more (including 100%) in the beverage as the concentration of the extracted liquid or a solid content.

### (Raw Materials of Tea Leaves)

Raw tea leaves for the green tea beverage in the present invention are not particularly limited in the types of green teas. For example, the types of green teas may broadly encompass teas that are classified as non-fermented tea, such as steamed tea (“Mushicha”), decocted tea (“Sencha”), refined green tea (“Gyokuro”), powdered green tea (“Maccha”), coarse tea (“Bancha”), curly green tea (“Tamaryokucha”), oven-roasted tea (“Kamairicha”) and Chinese green tea, and may also encompass those blended in two or more types thereof. In addition, cereals such as brown rice, flavors such as jasmine and other appropriate additives may be added thereto.

### (Concentration of Suspended Solids (SS))

The concentration of suspended solids (SS) as referred to in the present invention is one of indicators that are indicative of a degree of turbidity of water color, and is represented as a weight concentration (mg/L). The suspended solids (SS) refer collectively to insoluble substances that are suspended in water and have a particle diameter of 2 mm or less.

The concentration of suspended solids may be measured by a glass fiber filter paper method or a centrifugal separation method, among which the glass fiber filter paper method is ordinarily used, and the centrifugal separation method may be applied to samples that are difficult to be filtrated. The glass fiber filter paper method may be performed such that: a sample is suctioned to be filtrated using a glass fiber filter paper having a pore diameter of 1 μm; the residue after the filtration is dried at 105° C. to 110° C. for 2 hours; and thereafter the weight of the residue is measured. There is also another method for obtaining a concentration value of suspended solids in a more simplified manner utilizing a property that the concentration value of suspended solids is equal to the reciprocal of a transparency. The measurement of the concentration of suspended solids in the present invention is supposed to be performed by a measurement method using the above simplified method, but does not exclude employing measured values obtained through a strict measurement method within a scope which a person skilled in the art would ordinarily carry on.

### (Concentration of Suspended Solids (SS) in Green Tea Beverage)

The concentration of suspended solids (SS) in the green tea beverage according to the present invention may preferably be 15 to 80 mg/L, more preferably 20 to 80 mg/L, further preferably 30 to 70 mg/L, and most preferably 40 to 60 mg/L. If the concentration of suspended solids (SS) in the green tea beverage packed in a container is less than 15 mg/L, the concentration feeling (richness) in the taste of the green tea beverage will be insufficient, thus being undesirable. If the concentration of suspended solids (SS) in the green tea beverage packed in a container is more than 80 mg/L, the refreshing taste of the green tea beverage will be insufficient and sediments will extremely readily occur to cause poor appearance, thus being undesirable.

### (Concentration of Settleable Suspended Solids (SSS))

The concentration of settleable suspended solids (SSS) as referred to in the present invention is a concentration of substances that settle down when the sample water is placed stationarily for a constant period of time, and may be obtained as a difference between the concentration of suspended solids (SS) in the supernatant before the stationary placement and the concentration of suspended solids (SS) in the supernatant after the stationary placement.

### (Concentration of Settleable Suspended Solids (SSS) in Green Tea Beverage)

The concentration of settleable suspended solids (SSS) in the green tea beverage according to the present invention may preferably be 3 to 30 mg/L, more preferably 4 to 17 mg/L, further preferably 5 to 16.5 mg/L, still further preferably 6 to 16 mg/L, and most preferably 8 to 15 mg/L. If the concentration of settleable suspended solids (SSS) in the green tea beverage packed in a container is less than 3 mg/L, the concentration feeling (richness) in the taste of the green tea beverage will be insufficient, thus being undesirable. If the concentration of settleable suspended solids (SSS) in the green tea beverage packed in a container is more than 30 mg/L, sediments will extremely readily occur to cause poor appearance, thus being undesirable.

### (Ratio (SSS/SS) of Concentration of Settleable Suspended Solids (SSS) to Concentration of Suspended Solids (SS))

The ratio (SSS/SS) of the concentration of settleable suspended solids (SSS) to the concentration of suspended solids (SS) in the green tea beverage according to the present invention is preferably 0.07 to 0.48, more preferably 0.07 to 0.45, further to preferably 0.08 to 0.43, still further preferably 0.10 to 0.40, and most preferably 0.10 to 0.35. If the ratio (SSS/SS) of the concentration of settleable suspended solids (SSS) to the concentration of suspended solids (SS) in the green tea beverage packed in a container is less than 0.07, the feeling of taste and aroma and the texture will be unduly poor when the green tea beverage is drunk cold, thus being undesirable. If the ratio (SSS/SS) of the concentration of settleable suspended solids (SSS) to the concentration of suspended solids (SS) in the green tea beverage packed in a container is more than 0.48, sediments will be accumulate at the bottom of the container, thus being visually undesirable.

### (Method of Adjusting Concentration of Suspended Solids (SS) and Concentration of Settleable Suspended Solids (SSS))

The concentration of suspended solids (SS) and the concentration of settleable suspended solids (SSS) in the green tea beverage can be adjusted by the type of raw tea used in manufacturing the green tea beverage, the tea-picking season (“Chaki”), the method of heating (“Hiire”)/processing, mixing of two or more different types of raw teas, conditions for extraction, additives such as vitamin C, or mixing of two or more different types of extracted tea liquids.

For example, the concentration of suspended solids (SS) in the green tea beverage can be increased by: selecting tea leaves that contain a large amount of fine powder (such as deeply steamed decocted tea (“Fukamushi-sencha”), dust tea (“Konacha”) and powder tea (“Funmatsucha”)) as the raw tea; and performing extraction which may cut/break the tea leaves, such as compressive extraction and extraction with stirring. The concentration of suspended solids (SS) in the green tea beverage can be reduced by: selecting tea leaves that contain a small amount of fine powder (such as oven-roasted tea (“Kamairicha”) and decocted tea (“Sencha”) subjected to powder elimination); mixing one type of the tea leaves or mixing plural types of the tea leaves at an appropriate ratio; performing extraction which may not cut/break the tea leaves, such as shower extraction using a column-type extractor; and performing filtration (such as cake filtration) of the extracted liquid. The concentration of suspended solids (SS) can also be adjusted by mixing a green tea beverage having a high concentration of suspended solids (SS) and a green tea beverage having a low concentration of suspended solids (SS) at an appropriate ratio.

The concentration of settleable suspended solids (SSS) in the green tea beverage can be increased, for example, by: selecting tea leaves having a large specific gravity (such as first-picked tea leaves (“Ichibancha”), weakly heated tea leaves and real tea (“Honcha”)) as the raw tea; selecting tea leaves that contain fine powder having a further large specific gravity (such as tea leaves obtained by suspending powder tea (“Funmatsucha”) in water and recovering the settled tea leaves after a certain period of time has passed); and reducing the specific gravity of the green tea beverage. The concentration of settleable suspended solids (SSS) in the green tea beverage can be reduced, for example, by: selecting tea leaves having a small specific gravity (such as coarse tea (“Bancha”), strongly heated tea leaves and twig tea (“Kukicha”)) as the raw tea; removing fine powder of a large specific gravity from the extracted liquid (such as by centrifugal separation); and increasing the specific gravity of the green tea beverage. The concentration of settleable suspended solids (SSS) can also be adjusted by appropriately adjusting conditions of the temperature and pH of the liquid, the flow rate of the liquid passing through the centrifugal separator, and the rotation speed and the centrifugal settling area (Σ) of the centrifugal separator when the liquid such as the extracted liquid containing fine powder is subjected to centrifugal separation.

Since the ratio of the concentration of settleable suspended solids (SSS)/the concentration of suspended solids (SS) is obtained by dividing the concentration of settleable suspended solids (SSS) by the concentration of suspended solids (SS), the ratio can be adjusted on the basis of the method of adjusting them.

### (Monosaccharide)

The monosaccharide is a carbohydrate substance represented by a general formula C₆(H₂O)₆, and is not to be hydrolyzed any more to further simple sugar. The monosaccharide as referred to in the present invention represents glucose (grape sugar) or fructose (fruit sugar).

The concentration of monosaccharide in the green tea beverage according to the present invention may preferably be 8 to 120 ppm, more preferably 10 to 90 ppm, further preferably 12 to 80 ppm, and most preferably 12 to 70 ppm. If the concentration of monosaccharide in the green tea beverage packed in a container is less than 8 ppm, the concentration feeling (richness) in the taste of the green tea beverage will be insufficient, thus being undesirable. If the concentration of monosaccharide in the green tea beverage packed in a container is more than 120 ppm, the refreshing taste of the green tea beverage will be insufficient, thus being undesirable.

### (Disaccharide)

The disaccharide is a carbohydrate substance represented by a general formula C₁₂(H₂O)₁₁, and is to be hydrolyzed to provide a monosaccharide. The disaccharide as referred to in the present invention represents sucrose (cane sugar), cellobiose or maltose (malt sugar).

The concentration of disaccharide in the green tea beverage according to the present invention may preferably be 77 to 215 ppm, more preferably 80 to 180 ppm, further preferably 85 to 165 ppm, and most preferably 90 to 150 ppm. If the concentration of disaccharide in the green tea beverage packed in a container is less than 77 ppm, the concentration feeling (richness) in the taste of the green tea beverage will be insufficient, thus being undesirable. If the concentration of disaccharide in the green tea beverage packed in a container is more than 215 ppm, the refreshing taste of the green tea beverage will be insufficient, thus being undesirable.

### (Concentration of Sugars)

The “concentration of sugars being a sum of a concentration of monosaccharide and a concentration of disaccharide” as referred to in the present invention is to be obtained by summing up the concentration of the above monosaccharide and the concentration of the above disaccharide.

The “concentration of sugars being a sum of a concentration of monosaccharide and a concentration of disaccharide” in the green tea beverage according to the present invention may preferably be 85 ppm to 330 ppm, more preferably 90 ppm to 260 ppm, further preferably 95 ppm to 250 ppm, and most preferably 100 ppm to 200 ppm. If the “concentration of sugars being a sum of a concentration of monosaccharide and a concentration of disaccharide” in the green tea beverage packed in a container is less than 85 ppm, the concentration feeling (richness) in the taste of the green tea beverage will be insufficient, thus being undesirable. If the “concentration of sugars being a sum of a concentration of monosaccharide and a concentration of disaccharide” in the green tea beverage packed in a container is more than 330 ppm, the refreshing taste of the green tea beverage will be insufficient, thus being undesirable.

The ratio of the concentration of disaccharide to the concentration of monosaccharide (disaccharide/monosaccharide) is not particularly limited, but may be less than 10.0, 1.0 to 8.0, or 1.5 to 8.0.

### (Concentration of Sucrose)

The sucrose as referred to in the present invention is one type of disaccharides in which glucose (grape sugar) and fructose (fruit sugar) are combined.

The concentration of sucrose in the green tea beverage according to the present invention may preferably be 75 to 210 ppm, more preferably 80 to 180 ppm, further preferably 82 to 165 ppm, and most preferably 88 to 150 ppm. If the concentration of sucrose in the green tea beverage packed in a container is less than 75 ppm, the bitter taste (“Nigami”) of the green tea beverage will be remarkable, thus being undesirable. If the concentration of sucrose in the green tea beverage packed in a container is more than 210 ppm, the harsh taste (“Egumi”) of the green tea beverage will be remarkable, thus being undesirable.

### (Ratio of Concentration of Sucrose to Concentration of Sugars (Sucrose/Sugars))

The “ratio of the concentration of sucrose to the concentration of sugars (sucrose/sugars)” as referred to in the present invention is a ratio of the concentration of sucrose to the concentration of sugars, which is the sum of the concentration of the above monosaccharide and the concentration of the above disaccharide (sucrose/sugars). The “sucrose/sugars” in the present invention is preferably 0.63 to 0.90, more preferably 0.66 to 0.88, further preferably 0.68 to 0.85, and most preferably 0.69 to 0.82. If the “sucrose/sugars” in the green tea beverage packed in a container is less than 0.63, the sweet fire aroma of the green tea beverage will be insufficient, thus being undesirable. If the “sucrose/sugars” in the green tea beverage packed in a container is more than 0.90, the fresh aroma of the green tea beverage will be insufficient, thus being undesirable.

### (Method of Adjusting Concentration/Ratio of Sugars)

The concentration of sugars and the ratio of sugars can be adjusted within the above ranges by employing appropriate conditions for the drying (heating) process for the tea leaves and extraction, for example, as described in U.S. Pat. No. 4,843,118. For example, when the drying (heating) process for the tea leaves is performed in an enhanced manner, the sugars are decomposed to decrease, and when the extraction is performed at a high temperature for a long time, the sugars are also decomposed to decrease. Thus, the concentration of sugars and the ratio of sugars can be adjusted by the conditions for the drying (heating) process for the tea leaves and the conditions for extraction.

Here, the adjustment can be possible by adding sugars, but in this case there may be a risk that the flavor balance possessed originally by the green tea beverage will be disrupted. Therefore, the method of adjustment may preferably be performed without adding sugars, such as by adjusting conditions for obtaining a tea extracted liquid, adjusting the mixing ratio of plural different tea extracted liquids, and adding a tea extracted material and/or a tea refined material, for example.

### (Concentration of Catechins)

The concentration of catechins in the green tea beverage according to the present invention may preferably be 300 ppm to 600 ppm, more preferably 320 ppm to 550 ppm, further preferably 350 ppm to 500 ppm, and most preferably 350 ppm to 450 ppm. If the concentration of catechins in the green tea beverage packed in a container is less than 300 ppm, the sweet fire aroma may be enhanced, but the balance will be affected such as due to unduly weak fresh aroma and insufficient concentration feeling, thus being undesirable. If the concentration of catechins in the green tea beverage packed in a container is more than 600 ppm, the fresh aroma may be enhanced, but the balance will be affected such that the sweet fire aroma may be unduly weakened and the bitter and astringent taste and the harsh taste may be unduly enhanced, thus being undesirable.

Here, the total catechins mean total 8 types of catechin (C), gallocatechin (GC), catechin gallate (Cg), gallocatechin gallate (GCg), epicatechin (EC), epigallocatechin (EGC), epicatechin gallate (ECg) and epigallocatechin gallate (EGCg), and the concentration of the total catechins means the total value of the concentrations of the 8 type catechins.

The concentration of the total catechins may be adjusted within the above range by adjusting the conditions for extraction. Here, the adjustment can be possible by adding catechins, but in this case there may be a risk that the balance of the green tea beverage will be disrupted. Therefore, the adjustment may preferably be performed such as by adjusting conditions for obtaining a tea extracted liquid as well as by mixing tea extracted liquids with each other or by adding a tea extracted material.

### (Epimeric Catechins/Non-Epimeric Catechins)

The catechins in the green tea beverage according to the present invention may contain “epimeric catechins”, i.e., (−) EC, (−) EGC, (−) ECg and (−) EGCg, and may contain “non-epimeric catechins”, i.e., (−) C, (−) GC, (−) Cg and (−) GCg. The “non-epimeric catechins” can be obtained by performing heat treatment at a temperature of about 80° C. or more to facilitate thermal isomerization (epimerization). The “ratio of the epimeric catechins to the non-epimeric catechins (concentration of epimeric catechins/concentration of non-epimeric catechins)” in the green tea beverage according to the present invention may preferably be 0.4 to 10.0, further preferably 0.5 to 3.0, and most preferably 0.6 to 1.5.

### (Concentration of Electron-Localized Catechin)

The concentration of electron-localized catechin in the green tea beverage according to the present invention may preferably be 270 ppm to 550 ppm, more preferably 300 ppm to 500 ppm, and further preferably 320 ppm to 400 ppm.

The “electron-localized catechin” as referred to in the present invention is a catechin that has a triol structure (a structure having 3 OH groups adjacent to the benzene ring) and is considered to be likely to cause localization of the electric charge when ionized. Specific examples thereof include epigallocatechin gallate (EGCg), epigallocatechin (EGC), epicatechin gallate (ECg), gallocatechin gallate (GCg), gallocatechin (GC), and catechin gallate (Cg).

The concentration of the electron-localized catechin may be adjusted within the above range by adjusting the conditions for extraction, but an unduly high temperature and an unduly long extraction time may be undesirable from an aspect of maintaining the aroma of the beverage because the concentration of the electron-localized catechin may readily change depending on the extraction time and the temperature. Here, the adjustment can be possible by adding the electron-localized catechin, but in this case there may be a risk that the balance of the green tea beverage will be disrupted. Therefore, the adjustment may preferably be performed such as by adjusting conditions for obtaining a tea extracted liquid as well as by mixing tea extracted liquids with each other or by adding a tea extracted material.

### (Ratio of Concentration of Electron-Localized Catechin to Concentration of Sugars (Electron-Localized Catechin/Sugars))

The “ratio of the concentration of the electron-localized catechin to the concentration of the sugars (electron-localized catechin/sugars)” in the green tea beverage according to the present invention may preferably be 1.8 to 3.5, more preferably 2.0 to 3.3, and further preferably 2.3 to 3.0.

The ratio of the concentration of the electron-localized catechin to the concentration of the sugars may be adjusted within the above range by adjusting the conditions for extraction, but the extraction time may preferably be short because the extraction rate of catechin is high at a high temperature while the high temperature state causes the sugars to readily decompose. Here, the adjustment can be possible by adding the electron-localized catechin and the sugars, but in this case there may be a risk that the balance of the green tea beverage will be disrupted. Therefore, the adjustment may preferably be performed such as by adjusting conditions for obtaining a tea extracted liquid as well as by mixing tea extracted liquids with each other or by adding a tea extracted material.

### (Concentration of Caffeine)

The concentration of caffeine in the green tea beverage according to the present invention may preferably be less than 200 ppm, more preferably 0 ppm to 100 ppm, further preferably 0 ppm to 80 ppm, still further preferably 0 ppm to 60 ppm, yet further preferably 0 ppm to 40 ppm, and most preferably 0 ppm to 30 ppm. If the concentration of caffeine in the green tea beverage packed in a container is more than 200 ppm, the bitter taste originated from caffeine will affect the balance between the feeling of aroma and the bitter taste, thus being undesirable.

The concentration of caffeine may be adjusted within the above range through: dissolving caffeine in the tea leaves into water such as by spraying hot water to the tea leaves and immersing the tea leaves in hot water; using the tea leaves to produce tea extracted liquids; and mixing the tea extracted liquids with each other. The caffeine may also be adsorbed to be removed by causing an adsorbent such as active carbon and white clay to act with the extracted liquid.

### (Ratio of Concentration of Total Catechins to Concentration of Caffeine (Total Catechins/Caffeine))

The “ratio of the concentration of total catechins to the concentration of caffeine (total catechins/caffeine)” in the present invention may preferably be 1.4 to 600, more preferably 2.0 to 350, and most preferably 4.0 to 200. If the ratio of the concentration of total catechins to the concentration of caffeine (total catechins/caffeine) in the green tea beverage packed in a container is less than 1.4, the bitter taste will be excessively remarkable relative to the thickness/concentration feeling to disrupt the balance, thus being undesirable. If the ratio of the concentration of total catechins to the concentration of caffeine (total catechins/caffeine) in the green tea beverage packed in a container is more than 660, the astringent taste will be excessively remarkable relative to the thickness/concentration feeling to disrupt the balance, thus being undesirable.

The ratio of the concentration of total catechins to the concentration of caffeine can be adjusted within the above range by the caffeine reducing process as described above or adjusting the amount of the tea leaves and the extraction temperature. The adjustment can also be possible by adding the total catechins, but in this case there may be a risk that the balance of the green tea beverage will be disrupted. Therefore, the adjustment may preferably be performed such as by adjusting conditions for obtaining a tea extracted liquid as well as by mixing tea extracted liquids with each other or by adding a tea extracted material.

(pH)

The pH of the green tea beverage according to the present invention may preferably be 6.0 to 6.5 at 20° C. The pH of the present green tea beverage packed in a container may more preferably be 6.0 to 6.4, and particularly further preferably 6.1 to 6.3.

### (Method of Measuring Each Component)

A calibration curve method such as using high-performance liquid chromatogram (HPLC) or other appropriate method may be employed to measure the concentrations of the above monosaccharides, disaccharides, total catechins, electron-localized catechins and caffeine.

### (Container)

A container to be filled with the green tea beverage according to the present invention is not particularly limited. For example, a plastic-made bottle (so-called PET bottle), a can of a metal such as steel and aluminum, a bottle, a paper container and the like may be used. In particular, a transparent container or the like, such as a PET bottle, may preferably be used as the container.

### (Manufacturing Method)

The green tea beverage according to the present invention can be manufactured, for example, by selecting raw materials of tea leaves and appropriately adjusting conditions for a drying (heating) process and extraction for the tea leaves, thereby to adjust the ratio (SSS/SS) of the concentration of settleable suspended solids (SSS) to the concentration of suspended solids (SS) to 0.07 to 0.48 and adjust the ratio (sucrose/sugars) of the concentration of sucrose to the concentration of sugars, which is the sum of the concentration of monosaccharide and the concentration of disaccharide, to 0.63 to 0.90. For example, the green tea beverage according to the present invention can be manufactured through: preparing an extracted liquid that is obtained by subjecting tea leaves to a drying (heating) process at 250° C. to 260° C. and extracting the tea leaves at a high temperature for a short time; also preparing a conventional general green tea extracted liquid, i.e., an extracted liquid that is obtained by subjecting tea leaves to a drying (heating) process at 90° C. to 100° C. and extracting the tea leaves at a low temperature for a long time; and then blending them in an appropriate ratio. The green tea beverage according to the present invention can also be manufactured through subjecting an extracted liquid to a centrifugal separation process of which the conditions are appropriately adjusted or adjusting a turbid liquid of crushed tea leaves under an appropriate condition to be subjected to a centrifugal separation process and mixing the separated liquid with an extracted liquid. Note, however, that the method of manufacturing a green tea beverage according to the present invention is not limited to those described above.

### Examples

Examples of the present invention will hereinafter be described, but the present invention is not limited to the examples as described below.

### (Green Tea Leaves Extracted Liquid A)

A green tea leaves extracted liquid A was obtained through: extracting 20 g of green tea leaves for extracted liquid (Yabukita species, deeply steamed second-picked tea leaves produced in Shizuoka Prefecture, dried tea leaves (“Aracha”)) with 700 mL of hot water (80° C.) for 6 minutes; performing filtration using a stainless mesh (20 mesh) to remove the tea dregs; thereafter further performing filtration using a stainless mesh (80 mesh); processing the filtrated liquid using a centrifugal separator (SA1 continuous centrifugal separator available from Westphalia) under the conditions of a flow rate of 300 L/hr, a rotation speed of 10000 rpm, and a centrifugal settling area (Σ) of 1000 m²; and diluting the liquid with water to 700 ml using a measuring cylinder.

### (Green Tea Leaves Extracted Liquid B)

A green tea leaves extracted liquid B was obtained through: extracting 14 g of green tea leaves for extracted liquid (Yabukita species, deeply steamed second-picked tea leaves produced in Shizuoka Prefecture), which were subjected to a heating process at 285° C. for 8 minutes using a rotative drum-type heating machine, with 700 mL of hot water (60° C.) for 6 minutes; performing filtration using a stainless mesh (20 mesh) to remove the tea dregs; thereafter further performing filtration using a stainless mesh (80 mesh); processing the filtrated liquid using a centrifugal separator (SA1 continuous centrifugal separator available from Westphalia) under the conditions of a flow rate of 300 L/hr, a rotation speed of 10000 rpm, and a centrifugal settling area (Σ) of 1000 m²; and diluting the liquid with water to 700 ml using a measuring cylinder.

### (Crushed Tea Leaves for Turbid Liquid)

Crushed tea leaves for a turbid liquid were obtained by crushing green tea leaves (Yabukita species, deeply steamed first-picked tea leaves produced in Shizuoka Prefecture, dried tea leaves (“Aracha”)) using a jet mill (437-type available from NIPPON KANRYU INDUSTRY CO., LTD) under the conditions of a throughput of 10 kg/hr and a discharge pressure of 0.9 MPa.

### (Crushed Tea Leaves Turbid Liquid C)

A crushed tea leaves turbid liquid C was obtained through: dispersing the above-described crushed tea leaves for turbid liquid (5.6 g) in 300 mL of water using a high-speed homogenizer; processing the dispersed liquid using a centrifugal separator (SA1 continuous centrifugal separator available from Westphalia) under the conditions of a flow rate of 480 L/hr, a rotation speed of 10000 rpm, and a centrifugal settling area (Σ) of 1000 m²; and diluting the liquid with water to 700 ml using a measuring cylinder. The concentration of suspended solids (SS) in the crushed tea leaves turbid liquid C was 400 mg/L.

### (Crushed Tea Leaves Turbid Liquid D)

A crushed tea leaves turbid liquid D was obtained through: dispersing the above-described crushed tea leaves for turbid liquid (0.56 g) in 300 mL of water using a high-speed homogenizer; and diluting the dispersed liquid with water to 700 ml using a measuring cylinder. The concentration of suspended solids (SS) in the crushed tea leaves turbid liquid D was 400 mg/L.

### (Worked Product 1)

Compounding was performed using 700 ml of a mixture liquid of the green tea leaves extracted liquids A and B (compounding ratio (weight ratio) of green tea leaves extracted liquid A:green tea leaves extracted liquid B was 15:85) and 350 ml of a mixture liquid of the crushed tea leaves turbid liquids C and D (compounding ratio (weight ratio) of crushed tea leaves turbid liquid C:crushed tea leaves turbid liquid D was 20:80) so that a target concentration of suspended solids (SS) would be 70 mg/L; vitamin C was added thereto to be 350 ppm; sodium bicarbonate was added thereto to adjust the pH so that the pH of a heat sterilization process would be 6.2; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 1) was thereby obtained.

### (Worked Product 2)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 3:97) and a mixture liquid of the crushed tea leaves turbid liquids C and D (compounding ratio (weight ratio) of crushed tea leaves turbid liquid C:crushed tea leaves turbid liquid D was 20:80) so that a target concentration of suspended solids (SS) would be 50 mg/L; vitamin C was added thereto to be 400 ppm; sodium bicarbonate was added thereto to adjust the pH so that the pH of a heat sterilization process would be 6.2; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 2) was thereby obtained.

### (Worked Product 3)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 31:69) and a mixture liquid of the crushed tea leaves turbid liquids C and D (compounding ratio (weight ratio) of crushed tea leaves turbid liquid C:crushed tea leaves turbid liquid D was 70:30) so that a target concentration of suspended solids (SS) would be 50 mg/L; vitamin C was added thereto to be 350 ppm; sodium bicarbonate was added thereto to adjust the pH so that the pH of a heat sterilization process would be 6.3; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 3) was thereby obtained.

### (Worked Product 4)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 5:95) and a mixture liquid of the crushed tea leaves turbid liquids C and D (compounding ratio (weight ratio) of crushed tea leaves turbid liquid C:crushed tea leaves turbid liquid D was 70:30) so that a target concentration of suspended solids (SS) would be 50 mg/L; vitamin C was added thereto to be 400 ppm; sodium bicarbonate was added thereto to adjust the pH so that the pH of a heat sterilization process would be 6.3; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 4) was thereby obtained.

### (Worked Product 5)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 15:85) and a mixture liquid of the crushed tea leaves turbid liquids C and D (compounding ratio (weight ratio) of crushed tea leaves turbid liquid C:crushed tea leaves turbid liquid D was 50:50) so that a target concentration of suspended solids (SS) would be 50 mg/L; vitamin C was added thereto to be 350 ppm; sodium bicarbonate was added thereto to adjust the pH so that the pH of a heat sterilization process would be 6.4; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 5) was thereby obtained.

### (Worked Product 6)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 6:94) and a mixture liquid of the crushed tea leaves turbid liquids C and D (compounding ratio (weight ratio) of crushed tea leaves turbid liquid C:crushed tea leaves turbid liquid D was 50:50) so that a target concentration of suspended solids (SS) would be 50 mg/L; vitamin C was added thereto to be 400 ppm; sodium bicarbonate was added thereto to adjust the pH so that the pH of a heat sterilization process would be 6.2; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 6) was thereby obtained.

### (Worked Product 7)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 6:94) and a mixture liquid of the crushed tea leaves turbid liquids C and D (compounding ratio (weight ratio) of crushed tea leaves turbid liquid C:crushed tea leaves turbid liquid D was 50:50) so that a target concentration of suspended solids (SS) would be 20 mg/L; vitamin C was added thereto to be 450 ppm; sodium bicarbonate was added thereto to adjust the pH so that the pH of a heat sterilization process would be 6.3; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 7) was thereby obtained.

### (Worked Product 8)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 6:94) and a mixture liquid of the crushed tea leaves turbid liquids C and D (compounding ratio (weight ratio) of crushed tea leaves turbid liquid C:crushed tea leaves turbid liquid D was 50:50) so that a target concentration of suspended solids (SS) would be 70 mg/L; vitamin C was added thereto to be 400 ppm; sodium bicarbonate was added thereto to adjust the pH so that the pH of a heat sterilization process would be 6.2; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Worked Product 8) was thereby obtained.

### (Comparative Product 1)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 35:65) and a mixture liquid of the crushed tea leaves turbid liquids C and D (compounding ratio (weight ratio) of crushed tea leaves turbid liquid C:crushed tea leaves turbid liquid D was 0:100) so that a target concentration of suspended solids (SS) would be 50 mg/L; vitamin C was added thereto to be 450 ppm; sodium bicarbonate was added thereto to adjust the pH so that the pH of a heat sterilization process would be 6.2; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 1) was thereby obtained.

### (Comparative Product 2)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 2:98) and a mixture liquid of the crushed tea leaves turbid liquids C and D (compounding ratio (weight ratio) of crushed tea leaves turbid liquid C:crushed tea leaves turbid liquid D was 0:100) so that a target concentration of suspended solids (SS) would be 50 mg/L; vitamin C was added thereto to be 400 ppm; sodium bicarbonate was added thereto to adjust the pH so that the pH of a heat sterilization process would be 6.0; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 2) was thereby obtained.

### (Comparative Product 3)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 50:50) and a mixture liquid of the crushed tea leaves turbid liquids C and D (compounding ratio (weight ratio) of crushed tea leaves turbid liquid C:crushed tea leaves turbid liquid D was 20:80) so that a target concentration of suspended solids (SS) would be 50 mg/L; vitamin C was added thereto to be 450 ppm; sodium bicarbonate was added thereto to adjust the pH so that the pH of a heat sterilization process would be 6.1; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 3) was thereby obtained.

### (Comparative Product 4)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 0:100) and a mixture liquid of the crushed tea leaves turbid liquids C and D (compounding ratio (weight ratio) of crushed tea leaves turbid liquid C:crushed tea leaves turbid liquid D was 20:80) so that a target concentration of suspended solids (SS) would be 50 mg/L; vitamin C was added thereto to be 400 ppm; sodium bicarbonate was added thereto to adjust the pH so that the pH of a heat sterilization process would be 6.0; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 4) was thereby obtained.

### (Comparative Product 5)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 48:52) and a mixture liquid of the crushed tea leaves turbid liquids C and D (compounding ratio (weight ratio) of crushed tea leaves turbid liquid C:crushed tea leaves turbid liquid D was 70:30) so that a target concentration of suspended solids (SS) would be 50 mg/L; vitamin C was added thereto to be 350 ppm; sodium bicarbonate was added thereto to adjust the pH so that the pH of a heat sterilization process would be 6.2; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 5) was thereby obtained.

### (Comparative Product 6)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 1:99) and a mixture liquid of the crushed tea leaves turbid liquids C and D (compounding ratio (weight ratio) of crushed tea leaves turbid liquid C:crushed tea leaves turbid liquid D was 70:30) so that a target concentration of suspended solids (SS) would be 50 mg/L; vitamin C was added thereto to be 350 ppm; sodium bicarbonate was added thereto to adjust the pH so that the pH of a heat sterilization process would be 6.1; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 6) was thereby obtained.

### (Comparative Product 7)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 38:62) and a mixture liquid of the crushed tea leaves turbid liquids C and D (compounding ratio (weight ratio) of crushed tea leaves turbid liquid C:crushed tea leaves turbid liquid D was 90:10) so that a target concentration of suspended solids (SS) would be 10 mg/L; vitamin C was added thereto to be 350 ppm; sodium bicarbonate was added thereto to adjust the pH so that the pH of a heat sterilization process would be 6.1; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 7) was thereby obtained.

### (Comparative Product 8)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 3:97) and a mixture liquid of the crushed tea leaves turbid liquids C and D (compounding ratio (weight ratio) of crushed tea leaves turbid liquid C:crushed tea leaves turbid liquid D was 90:10) so that a target concentration of suspended solids (SS) would be 10 mg/L; vitamin C was added thereto to be 200 ppm; sodium bicarbonate was added thereto to adjust the pH so that the pH of a heat sterilization process would be 6.2; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 8) was thereby obtained.

### (Comparative Product 9)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 2:98) and a mixture liquid of the crushed tea leaves turbid liquids C and D (compounding ratio (weight ratio) of crushed tea leaves turbid liquid C:crushed tea leaves turbid liquid D was 0:100) so that a target concentration of suspended solids (SS) would be 15 mg/L; vitamin C was added thereto to be 350 ppm; sodium bicarbonate was added thereto to adjust the pH so that the pH of a heat sterilization process would be 6.1; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 9) was thereby obtained.

### (Comparative Product 10)

Compounding was performed in a similar manner to that for Worked Product 1 using a mixture liquid of the green tea leaves extracted liquids A and B (compounding ratio (weight ratio) of green tea leaves extracted liquid A:green tea leaves extracted liquid B was 5:95) and a mixture liquid of the crushed tea leaves turbid liquids C and D (compounding ratio (weight ratio) of crushed tea leaves turbid liquid C:crushed tea leaves turbid liquid D was 0:100) so that a target concentration of suspended solids (SS) would be 80 mg/L; vitamin C was added thereto to be 600 ppm; sodium bicarbonate was added thereto to adjust the pH so that the pH of a heat sterilization process would be 6.2; and the liquid was then diluted with pure water to 2000 mL using a measuring cylinder. Thereafter, the mixture liquid thus obtained was subjected to UHT sterilization (135° C., 30 seconds), charged in a transparent plastic bottle (PET bottle) after being cooled to 85° C. in a plate, and immediately cooled to 20° C., and a green tea beverage packed in a container (Comparative Product 10) was thereby obtained.

### (Method of Measuring Each Component)

As described above, a calibration curve method such as using high-performance liquid chromatogram (HPLC) or other appropriate method was employed to measure the concentrations of the monosaccharides, disaccharides, total catechins, electron-localized catechins and caffeine.

With regard to the concentration of suspended solids (SS), a sample of 5° C. was prepared and measured in conformity with the method of JIS (Japanese Industrial Standards) K0102-9. Specifically, a filtering material (membrane filter (cellulose acetate type), pore diameter of 1 μm, diameter of 47 mm (available from Toyo Roshi Kaisha, Ltd.)) was attached to a filtering device; an appropriate amount (45 to 100 ml) of the sample was poured into the filtering device to undergo suction filtration; and the filtering material was then washed with 50 ml of pure water and brought out from the filtering device using tweezers to be dried at 90° C. for 30 minutes. The filtering material was allowed to be cooled in a desiccator, and the mass of residues on the filtering material was measured.

The concentration of settleable suspended solids (SSS) was obtained by measuring the concentration of suspended solids (SS) of a supernatant of the sample placed stationarily at 5° C. for 5 hours and calculating a difference from the concentration of suspended solids (SS) of the sample before the stationary placement (concentration of settleable suspended solids (SSS)=concentration of suspended solids (SS) before stationary placement−concentration of suspended solids (SS) after stationary placement (5° C., 5 hours).

### (Evaluation Method)

For all of Worked Products 1 to 8 and Comparative Products 1 to 10, ten persons of skilled panelists performed sensory evaluation immediately after opening (5° C.) (Sensory Evaluation 1) and sensory evaluation when 5 hours elapsed after opening (28° C. stationary placement) (Sensory Evaluation 2). Four-grade evaluation (1-point to 4-point) was performed and an average was calculated for each sample to classify the sample into “⊚” (4-point), “◯” (3-point), “Δ” (2-point) and “X” (1-point) in order from excellent evaluation. Evaluation items in each sensory evaluation were the sweet fire aroma, fresh aroma, concentration feeling (richness), refreshing taste, fragrant aroma, and aftertaste.

In addition, for all of Worked Products 1 to 8 and Comparative Products 1 to 10, the appearance of each sample after stationary placement at 37° C. for 10 days was evaluated in a similar manner to the above.

Furthermore, the “comprehensive evaluation” was performed by evaluating the suitability for a product of each green tea beverage packed in a container, including the taste, aroma, aftertaste, appearance and the like, in a similar manner to the above.

Tables 1 to 4 show the compounding ratio (weight) in each of Worked Products 1 to 8 and Comparative Products 1 to 10, the measurement results of each component, and the evaluation results of each sample.

TABLE 1

| | Worked | Worked | Worked | Worked |
|---|---|---|---|---|
| | Product 1 | Product 2 | Product 3 | Product 4 |
| Green tea leaves | 15 | 3 | 31 | 5 |
| extracted liquid A | | | | |
| Green tea leaves | 85 | 97 | 69 | 95 |
| extracted liquid B | | | | |
| Crushed tea leaves | 20 | 20 | 70 | 70 |
| turbid liquid C | | | | |
| Crushed tea leaves | 80 | 80 | 30 | 30 |
| turbid liquid D | | | | |
| | Worked | Worked | Worked | Worked |
| | Product 5 | Product 6 | Product 7 | Product 8 |
| Green tea leaves | 15 | 6 | 6 | 6 |
| extracted liquid A | | | | |
| Green tea leaves | 85 | 94 | 94 | 94 |
| extracted liquid B | | | | |
| Crushed tea leaves | 50 | 50 | 50 | 50 |
| turbid liquid C | | | | |
| Crushed tea leaves | 50 | 50 | 50 | 50 |
| turbid liquid D | | | | |

TABLE 2

| | Comparative | Comparative | Comparative | Comparative | Comparative |
|---|---|---|---|---|---|
| | Product 1 | Product 2 | Product 3 | Product 4 | product 5 |
| Green tea leaves | 35 | 2 | 50 | 0 | 48 |
| extracted liquid A | | | | | |
| Green tea leaves | 65 | 98 | 50 | 100 | 52 |
| extracted liquid B | | | | | |
| Crashed tea leaves | 0 | 0 | 20 | 20 | 70 |
| turbid liquid C | | | | | |
| Crashed tea leaves | 100 | 100 | 80 | 80 | 30 |
| turbid liquid D | | | | | |
| | Comparative | Comparative | Comparative | Comparative | Comparative |
| | Product 6 | Product 7 | Product 8 | Product 9 | product 10 |
| Green tea leaves | 1 | 38 | 3 | 2 | 5 |
| extracted liquid A | | | | | |
| Green tea leaves | 99 | 62 | 97 | 98 | 95 |
| extracted liquid B | | | | | |
| Crashed tea leaves | 70 | 90 | 90 | 0 | 0 |
| turbid liquid C | | | | | |
| Crushed tea leaves | 30 | 10 | 10 | 100 | 100 |
| turbid liquid D | | | | | |

TABLE 3

| | Worked | Worked | Worked | Worked | Worked | Worked | Worked | Worked |
|---|---|---|---|---|---|---|---|---|
| | Product 1 | product 2 | product 3 | product 4 | product 5 | product 6 | product 7 | product 8 |
| Concentration of | 72 | 51 | 47 | 45 | 55 | 52 | 20 | 68 |
| suspended solids (SS) | | | | | | | | |
| Concentration of | 31 | 20 | 6 | 3 | 14 | 12 | 5 | 18 |
| settleable suspended | | | | | | | | |
| solids (SSS) | | | | | | | | |
| SSS/SS | 0.43 | 0.39 | 0.13 | 0.07 | 0.25 | 0.23 | 0.25 | 0.26 |
| Disaccharide (ppm) | 118 | 81 | 165 | 87 | 117 | 90 | 89 | 91 |
| Monosaccharide + | 159 | 92 | 245 | 103 | 157 | 108 | 105 | 110 |
| disaccharide (ppm) | | | | | | | | |
| Sucrose (ppm) | 116 | 80 | 162 | 86 | 115 | 89 | 88 | 90 |
| Sucrose/ | 0.73 | 0.87 | 0.66 | 0.83 | 0.73 | 0.82 | 0.84 | 0.82 |
| (monosaccharide + | | | | | | | | |
| disaccharide) | | | | | | | | |
| Bx | 0.32 | 0.29 | 0.33 | 0.29 | 0.31 | 0.29 | 0.28 | 0.31 |
| Tannin (mg %) | 59 | 51 | 67 | 52 | 58 | 52 | 51 | 53 |
| pH | 6.2 | 6.2 | 6.3 | 6.3 | 6.4 | 6.2 | 6.3 | 6.2 |
| Electron-localized | 39 | 30 | 46 | 31 | 37 | 32 | 30 | 33 |
| catechins (mg %) | | | | | | | | |

Evaluation immediately after opening: 5° C.

| | | | | | | | | |
|---|---|---|---|---|---|---|---|---|
| Aroma (sweet fire | Δ | ◯ | Δ | ◯ | Δ | ◯ | ◯ | Δ |
| aroma) | | | | | | | | |
| Aroma (fresh aroma) | Δ | Δ | ◯ | Δ | ◯ | Δ | Δ | Δ |
| Concentration feeling | ⊚ | ⊚ | Δ | Δ | ◯ | ◯ | Δ | ⊚ |
| (richness) | | | | | | | | |
| Refreshing taste | ◯ | ◯ | ⊚ | ⊚ | ⊚ | ⊚ | ⊚ | ◯ |
| Fragrant aroma and | ◯ | ◯ | ⊚ | ⊚ | ⊚ | ⊚ | ⊚ | ◯ |
| aftertaste | | | | | | | | |

Evaluation when 5 hours elapsed after opening: 28° C.

| | | | | | | | | |
|---|---|---|---|---|---|---|---|---|
| Aroma (sweet fire | ◯ | ⊚ | ◯ | ⊚ | ◯ | ⊚ | ⊚ | ⊚ |
| aroma) | | | | | | | | |
| Aroma (fresh aroma) | ◯ | ◯ | ⊚ | ◯ | ⊚ | ◯ | ◯ | ◯ |
| Concentration feeling | ⊚ | ⊚ | Δ | Δ | ◯ | ◯ | Δ | ⊚ |
| (richness) | | | | | | | | |
| Refreshing taste | Δ | Δ | ◯ | ◯ | ◯ | ◯ | ⊚ | Δ |
| Fragrant aroma and | Δ | Δ | ◯ | ◯ | ◯ | ◯ | ⊚ | Δ |
| aftertaste | | | | | | | | |
| Temporal evaluation | Δ | Δ | ⊚ | ⊚ | ◯ | ◯ | ⊚ | Δ |
| (appearance) | | | | | | | | |
| Comprehensive | ◯ | ◯ | ◯ | ◯ | ⊚ | ⊚ | ◯ | ◯ |
| evaluation | | | | | | | | |

TABLE 4

| | Com- | Com- | Com | Com- | Com- | Com- | Com- | | | |
|---|---|---|---|---|---|---|---|---|---|---|
| | parative | parative | parative | parative | parative | parative | parative | Comparative | Comparative | Comparative |
| | Product 1 | product 2 | product 3 | product 4 | product 5 | product 6 | product 7 | product 8 | product 9 | product 10 |
| Concentration of | 47 | 46 | 52 | 50 | 52 | 53 | 12 | 13 | 14 | 82 |
| suspended solids (SS) | | | | | | | | | | |
| Concentration of | 26 | 23 | 22 | 17 | 5 | 4 | 0.5 | 0.7 | 7 | 40 |
| settleable suspended | | | | | | | | | | |
| solids (SSS) | | | | | | | | | | |
| SSS/SS | 0.55 | 0.5 | 0.42 | 0.34 | 0.1 | 0.08 | 0.04 | 0.05 | 0.5 | 0.49 |
| Disaccharide (ppm) | 177 | 78 | 223 | 72 | 217 | 75 | 183 | 79 | 77 | 89 |
| Monosaccharide + | 267 | 86 | 350 | 75 | 329 | 81 | 277 | 88 | 84 | 107 |
| disaccharide (ppm) | | | | | | | | | | |
| Sucrose (ppm) | 173 | 77 | 217 | 72 | 211 | 74 | 179 | 78 | 76 | 88 |
| Sucrose/ | 0.65 | 0.9 | 0.62 | 0.96 | 0.02 | 0.91 | 0.65 | 0.89 | 0.9 | 0.82 |
| (monosaccharide + | | | | | | | | | | |
| disaccharide) | | | | | | | | | | |
| Bx | 0.34 | 0.28 | 0.37 | 0.28 | 0.36 | 0.28 | 0.34 | 0.28 | 0.29 | 0.3 |
| Tannin (mg %) | 69 | 50 | 78 | 49 | 77 | 50 | 70 | 50 | 51 | 54 |
| pH | 6.2 | 6 | 6.1 | 6 | 6.2 | 6.1 | 6.1 | 6.2 | 6.1 | 6.2 |
| Electron-localized | 49 | 29 | 58 | 28 | 56 | 29 | 49 | 25 | 28 | 33 |
| catechins (mg %) | | | | | | | | | | |

Evaluation immediately after opening: 5° C.

| | | | | | | | | | | |
|---|---|---|---|---|---|---|---|---|---|---|
| Aroma (sweet fire | X | Δ | X | ◯ | X | ◯ | Δ | ◯ | ◯ | Δ |
| aroma) | | | | | | | | | | |
| Aroma (fresh aroma) | Δ | X | ◯ | X | ◯ | X | ◯ | Δ | Δ | X |
| Concentration feeling | ⊚ | ⊚ | ⊚ | ⊚ | Δ | Δ | X | X | Δ | ⊚ |
| (richness) | | | | | | | | | | |
| Refreshing taste | Δ | Δ | Δ | Δ | ◯ | ◯ | ⊚ | ⊚ | ◯ | X |
| Fragrant aroma and | Δ | Δ | ⊚ | ⊚ | ⊚ | ⊚ | ⊚ | ⊚ | ◯ | X |
| aftertaste | | | | | | | | | | |

Evaluation when 5 hours elapsed after opening: 28° C.

| | | | | | | | | | | |
|---|---|---|---|---|---|---|---|---|---|---|
| Aroma (sweet fire | Δ | ◯ | X | ⊚ | X | ⊚ | ◯ | ⊚ | ⊚ | Δ |
| aroma) | | | | | | | | | | |
| Aroma (fresh aroma) | ◯ | Δ | ⊚ | X | ⊚ | [symbol] | ⊚ | ◯ | ◯ | Δ |
| Concentration feeling | ⊚ | ⊚ | ⊚ | ⊚ | Δ | Δ | X | X | Δ | ⊚ |
| (richness) | | | | | | | | | | |
| Refreshing taste | X | X | X | X | Δ | Δ | ⊚ | ⊚ | Δ | X |
| Fragrant aroma and | X | X | Δ | Δ | ◯ | ◯ | ⊚ | ⊚ | Δ | X |
| aftertaste | | | | | | | | | | |
| Temporal evaluation | X | X | Δ | Δ | ⊚ | ⊚ | ⊚ | ⊚ | Δ | X |
| (appearance) | | | | | | | | | | |
| Comprehensive | Δ | Δ | Δ | Δ | Δ | Δ | Δ | Δ | Δ | Δ |
| evaluation | | | | | | | | | | |

[symbol]

indicates data missing or illegible when filed

### (Discussion)

With regard to Worked Products 1 to 8 according to the present invention, the evaluation when 5 hours elapsed after opening at 28° C. was good or very good for many items of the sweet fire aroma, fresh aroma, concentration feeling (richness) in the taste, refresh feeling, fragrant aroma, and aftertaste. Highly balanced products were thus able to be obtained each offering good comprehensive evaluation because the balance of the sweet fire aroma, fresh aroma, concentration feeling (richness) in the taste, refresh feeling, fragrant aroma and aftertaste was excellent and there was not any problem in appearance.

In contrast, each of Comparative Products 1 to 10 exhibited insufficient balance, such as that the appearance was undesirable (Comparative Products 1-2 and 10), the fragrant aroma and aftertaste were considerably undesirable (Comparative Products 1-2 and 10), the sweet fire aroma and fresh aroma were seriously insufficient (Comparative Products 3-6), the concentration feeling (richness) was seriously insufficient (Comparative Products 7-8), the refreshing taste and fragrant aroma deteriorated as time passed (Comparative Products 1-4 and 9), and the bitter/harsh taste occurred (Comparative Product 10). The comprehensive evaluation was thus not good in Comparative Products 1 to 10.

1. A green tea beverage packed in a container wherein:
a ratio of a concentration of settleable suspended solids to a concentration of suspended solids is 0.07 to 0.48, the suspended solids consisting of insoluble substances having a particle diameter of 2 mm or less; and
a ratio of a concentration of sucrose to a concentration of sugars is 0.63 to 0.90, the concentration of sugars being a sum of a concentration of monosaccharide and a concentration of disaccharide.

2. The green tea beverage packed in a container as recited in claim 1, wherein the concentration of settleable suspended solids is 3 to 30 mg/L.

3. The green tea beverage packed in a container as recited in claim 1, wherein the concentration of sugars, which is the sum of the concentration of monosaccharide and the concentration of disaccharide, is 85 ppm to 330 ppm.

4. The green tea beverage packed in a container as recited in claim 1, wherein a ratio of a concentration of electron-localized catechin to the concentration of sugars is 1.8 to 3.5.

5. A method of manufacturing a green tea beverage packed in a container, the method comprising:
adjusting a ratio of a concentration of settleable suspended solids to a concentration of suspended solids in the green tea beverage to 0.07 to 0.48, the suspended solids consisting of insoluble substances having a particle diameter of 2 mm or less; and
adjusting a ratio of a concentration of sucrose to a concentration of sugars to 0.63 to 0.90, the concentration of sugars being a sum of a concentration of monosaccharide and a concentration of disaccharide.

6. A method of maintaining a flavor of a green tea beverage, the method comprising:
adjusting a ratio of a concentration of settleable suspended solids to a concentration of suspended solids in the green tea beverage to 0.07 to 0.48, the suspended solids consisting of insoluble substances having a particle diameter of 2 mm or less; and
adjusting a ratio of a concentration of sucrose to a concentration of sugars to 0.63 to 0.90, the concentration of sugars being a sum of a concentration of monosaccharide and a concentration of disaccharide.

7. The green tea beverage packed in a container as recited in claim 2, wherein the concentration of sugars, which is the sum of the concentration of monosaccharide and the concentration of disaccharide, is 85 ppm to 330 ppm.

8. The green tea beverage packed in a container as recited in claim 2, wherein a ratio of a concentration of electron-localized catechin to the concentration of sugars is 1.8 to 3.5.

9. The green tea beverage packed in a container as recited in claim 3, wherein a ratio of a concentration of electron-localized catechin to the concentration of sugars is 1.8 to 3.5.
